(19) United States
(12) Patent Application Publication
(10) Pub. No.: US 2026/0170633 A1
(43) Pub. Date: Jun. 18, 2026

(54) GLASS TUBE PROCESSING PARAMETER DETECTION METHOD AND APPARATUS

(71) Applicants: CHINA BUILDING MATERIALS ACADEMY CO., LTD., Beijing (CN); China National Building Material Group Co., Ltd., Beijing (CN)

(72) Inventors: Ran Zhao, Beijing (CN); Yan Duan, Beijing (CN); Rui Zhang, Beijing (CN); Danqi Zhao, Beijing (CN); Hui Liu, Beijing (CN); Yajie Du, Beijing (CN); Bo Liu, Beijing (CN)

(73) Assignees: CHINA BUILDING MATERIALS ACADEMY CO., LTD., Beijing (CN); China National Building Material Group Co., Ltd., Beijing (CN)

(21) Appl. No.: 19/306,527

(22) Filed: Aug. 21, 2025

(30) Foreign Application Priority Data
Dec. 16, 2024 (CN) 2024118518822

(51) Int. Cl. G06T 7/00; G06T 5/20; G06T 5/70; G06T 7/12; G06T 7/62; G06T 7/66

(52) U.S. Cl. CPC G06T 7/0006; G06T 5/20; G06T 5/70; G06T 7/12; G06T 7/62; G06T 7/66; G06T 2207/30164

(57) ABSTRACT

A glass tube processing parameter detection method includes: acquiring an end face image of the glass tube; generating an edge binary image corresponding to the glass tube according to preset rules, a plurality of preset mask matrices, and the end face image, where the edge binary image includes a first circular ring composed of a plurality of first pixel points and a second circular ring composed of a plurality of second pixel points; determining a center coordinate of the first circular ring and a center coordinate corresponding to the second circular ring; determining an inner-circle processing diameter and an outer-circle processing diameter corresponding to the glass tube according to coordinates corresponding to each of the first pixel points and the second pixel points; determining a concentricity deviation value corresponding to the glass tube according to the center coordinate corresponding to the first circular ring and the second circular ring.

### TECHNICAL FIELD

The present application relates to the technical field of glass tube processing, and in particular, relates to a glass tube processing parameter detection method and apparatus.

### BACKGROUND

Optical fiber image transmission elements (such as fiber optical plates, fiber optical inverters, fiber optical tapers, etc.) are fiber optic material bundles composed of tens of thousands to hundreds of thousands of micron-level optical fibers. In which, the optical fibers constituting the optical fiber image transmission elements are fabricated by drawing a hollow glass tube over a core glass rod, on the other words, the optical fibers are composed of two kinds of glasses with different compositions (namely, core glass and clad glass) and glass rods made of core glass are inserted into glass tubes made of clad glass, and the two are heated and stretched together to make optical fibers, that is, the processing quality of the optical fibers depends on the processing quality of the glass tube. Only glass tubes with processing quality meeting requirements can produce optical fibers with processing quality meeting requirements. Therefore, to ensure the processing quality of optical fibers, it is necessary to detect the processing quality of glass tubes.

Wherein, this typically involves detecting the error value between the inner edge (that is, inner circle) processing diameter of the glass tube and the drawing diameter, detecting the error value between the outer edge (that is, outer circle) processing diameter of the glass tube and the drawing diameter, and detecting the concentricity deviation value between the inner circle and the outer circle of the glass tube. Then, based on the error value between the inner circle processing diameter of the glass tube and the drawing diameter, the error value between the outer circle processing diameter of the glass tube and the drawing diameter, and the concentricity deviation value between the inner circle and the outer circle of the glass tube, the processing quality of the glass tube is evaluated.

Currently, laser detection method is typically used to detect the error value between the inner circle processing diameter of the glass tube and the drawing diameter, the error value between the outer circle processing diameter of the glass tube and the drawing diameter, and the concentricity deviation value between the inner circle and the outer circle of the glass tube. Wherein, during the process of detecting the processing parameters of the glass tube using laser detection, two lasers are required to perform multiple point-scanning operations on the glass tube. However, completing these multiple point-scanning operations requires staff to manually rotate the glass tube multiple times or manually rotate the lasers multiple times. Therefore, using laser detection to detect the processing parameters of the glass tube consumes significant time costs and labor costs, resulting in low detection efficiency.

### SUMMARY OF THE INVENTION

An embodiment of the present application provides a glass tube processing parameter detection method, primarily aiming to improve the detection efficiency of detecting the glass tube processing parameters.

To solve the above technical problem, embodiments of the present application provide the following technical solutions:

In a first aspect, the present application provides a glass tube processing parameter detection method. The method including:
Acquiring an end face image corresponding to a glass tube to be detected, wherein the glass tube to be detected is a glass tube used for manufacturing optical fibers;
Generating an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points;
Determining a center coordinate corresponding to the first circular ring according to coordinates corresponding to each of the first pixel points, and determining a center coordinate corresponding to the second circular ring according to coordinates corresponding to each of the second pixel points;
Determining an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring;
Determining a concentricity deviation value corresponding to the glass tube to be detected according to the center coordinate corresponding to the first circular ring and the center coordinate corresponding to the second circular ring.

In a second aspect, the present application further provides a glass tube processing parameter detection apparatus, the apparatus including:
An acquisition unit, configured to acquire an end face image corresponding to a glass tube to be detected, wherein the glass tube to be detected is a glass tube used for manufacturing optical fibers;
A generation unit, configured to generate an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points;
A first determination unit, configured to determine a center coordinate corresponding to the first circular ring according to coordinates corresponding to each of the first pixel points, and determine a center coordinate corresponding to the second circular ring according to coordinates corresponding to each of the second pixel points;
A second determination unit, configured to determine an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring;
A third determination unit, configured to determine a concentricity deviation value corresponding to the glass tube to be detected according to the center coordinate corresponding to the first circular ring and the center coordinate corresponding to the second circular ring.

In a third aspect, an embodiment of the present application provides a storage medium, the storage medium includes a stored program, wherein the program, when executed, controls a device in which the storage medium is located to perform the glass tube processing parameter detection method according to the first aspect.

In a fourth aspect, an embodiment of the present application provides a glass tube processing parameter detection apparatus. The apparatus includes a storage medium; and one or more processors, the storage medium is coupled to the processor, and the processor is configured to execute program instructions stored in the storage medium; the program instructions, when running, execute the glass tube processing parameter detection method according to the first aspect.

By virtue of the above technical solutions, the technical solutions provided by the present application at least have the following advantages:

The present application provides a glass tube processing parameter detection method and apparatus. In the present application, after a glass tube processing parameter detection application acquires an end face image corresponding to a glass tube to be detected, the glass tube processing parameter detection application first generates an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points; then, determines a center coordinate corresponding to the first circular ring according to coordinates corresponding to each of the first pixel points, and determines a center coordinate corresponding to the second circular ring according to coordinates corresponding to each of the second pixel points; then, determines an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring; finally, determines a concentricity deviation value corresponding to the glass tube to be detected according to the center coordinate corresponding to the first circular ring and the center coordinate corresponding to the second circular ring. Since, in the present application, detection staff only need to pre-shoot the end face image of the glass tube to be detected, the glass tube processing parameter detection application can detect the processing parameters corresponding to the glass tube to be detected based on the end face image corresponding to the glass tube to be detected, without requiring intervention from detection staff throughout the entire process, this can effectively reduce the time costs and labor costs consumed in detecting the processing parameters of the glass tube to be detected, thereby effectively improving detection efficiency.

The above description is merely an overview of the technical solutions of the present application. To understand the technical means of the present application more clearly, it can be implemented according to the content of the specification. Furthermore, to make the above and other objectives, features, and advantages of the present application more comprehensible, specific implementations of the present application are described below.

### BRIEF DESCRIPTION OF THE DRAWINGS

Through reference to the drawings and reading the following detailed description, the above and other objectives, features, and advantages of the exemplary implementations of the present application will become easily comprehensible. In the drawings, several implementations of the present application are shown in an exemplary rather than restrictive manner, where identical or corresponding reference numerals denote identical or corresponding parts, wherein:

FIG. 1 shows a flowchart of a glass tube processing parameter detection method provided by an embodiment of the present application;

FIG. 2a shows a schematic diagram of an end face image corresponding to a glass tube to be detected provided by an embodiment of the present application;

FIG. 2b shows a schematic diagram of an edge binary image corresponding to a glass tube to be detected provided by an embodiment of the present application;

FIG. 2c shows a schematic diagram of a noise reduced image corresponding to a glass tube to be detected provided by an embodiment of the present application;

FIG. 2d shows a schematic diagram of a gradient image corresponding to a glass tube to be detected provided by an embodiment of the present application;

FIG. 2e shows a schematic diagram of an edge image corresponding to a glass tube to be detected provided by an embodiment of the present application;

FIG. 3 shows a flowchart of another glass tube processing parameter detection method provided by an embodiment of the present application;

FIG. 4 shows a block diagram of the composition of a glass tube processing parameter detection apparatus provided by an embodiment of the present application;

FIG. 5 shows a block diagram of the composition of another glass tube processing parameter detection apparatus provided by an embodiment of the present application.

### DETAILED DESCRIPTION OF EMBODIMENTS

The exemplary implementations of the present application will be described in more detail below with reference to the accompanying drawings. Although the exemplary implementations of the present application are shown in the drawings, it should be understood that the present application can be implemented in various forms and should not be limited by the implementations described herein. On the contrary, these implementations are provided to enable a more thorough understanding of the present application and to fully convey the scope of the present application to those skilled in the art.

Additionally, the terms “first”, “second”, and similar terms used in the present application do not denote any order, quantity, or importance, but are merely used to distinguish different parts.

It should be noted that unless otherwise specified, technical terms or scientific terms used in the present application shall have the ordinary meanings understood by those skilled in the art to which the present application pertains.

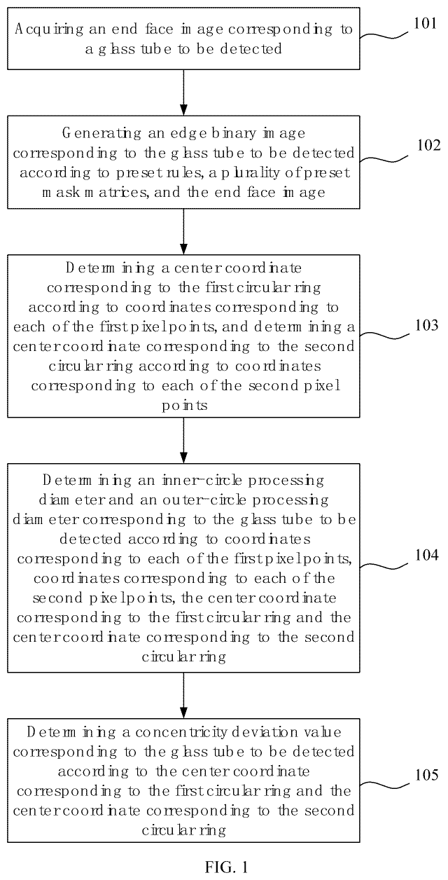

Currently, laser detection is typically used to detect the error value between the inner circle processing diameter of the glass tube and the drawing diameter, the error value between the outer circle processing diameter of the glass tube and the drawing diameter, and the concentricity deviation value between the inner circle and the outer circle of the glass tube. Wherein, during the process of detecting the processing parameters of the glass tube using laser detection, two lasers are required to perform multiple point-scanning operations on the glass tube. However, completing these multiple point-scanning operations requires staff to manually rotate the glass tube multiple times or manually rotate the lasers multiple times. Therefore, using laser detection to detect the processing parameters of the glass tube consumes significant time costs and labor costs, resulting in low detection efficiency. Therefore, to improve the detection efficiency of detecting the glass tube processing parameters, an embodiment of the present application provides a glass tube processing parameter detection method. As shown in FIG. 1, the method at least includes steps 101-105.

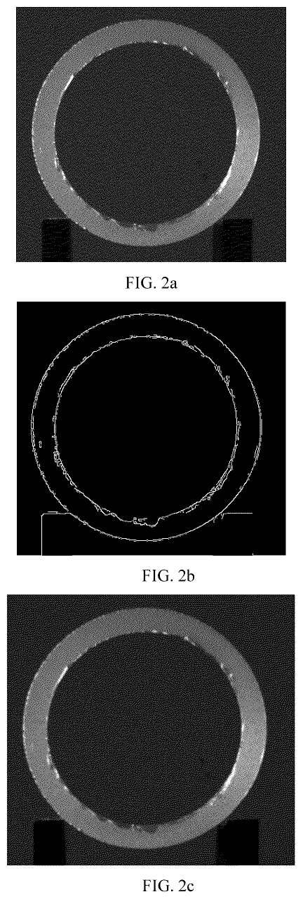

101: Acquiring an end face image corresponding to a glass tube to be detected.

Wherein, the glass tube to be detected is a glass tube used for manufacturing optical fibers; wherein, the end face image corresponding to the glass tube to be detected is an image obtained by pre-shooting the end face of the glass tube to be detected using an industrial camera, the end face image corresponding to the glass tube to be detected as specifically shown in FIG. 2a.

In the embodiments of the present application, the execution subject of each step is the glass tube processing parameter detection application running on a target terminal device, wherein the target terminal device may include, but is not limited to: computers, tablets, laptops, etc.

Detection staff will pre-shoot the end face of the glass tube to be detected using an industrial camera to obtain the end face image corresponding to the glass tube to be detected and store the end face image corresponding to the glass tube to be detected in the local storage space of the target terminal device. When it is necessary to detect the processing parameters corresponding to the glass tube to be detected, the glass tube processing parameter detection application can acquire the end face image from the local storage space of the target terminal device.

102: Generating an edge binary image corresponding to the glass tube to be detected according to preset rules, a plurality of preset mask matrices, and the end face image.

Wherein the edge binary image includes a first circular ring composed of a plurality of first pixel points and a second circular ring composed of a plurality of second pixel points. The first circular ring is the inner edge of the glass tube to be detected, and the second circular ring is the outer edge of the glass tube to be detected. The edge binary image is specifically shown in FIG. 2b; wherein the gray values of a plurality of the first pixel points and a plurality of the second pixel points are 1, and the gray values of other pixel points in the edge binary image are 0.

After the glass tube processing parameter detection application acquires an end face image corresponding to a glass tube to be detected, the glass tube processing parameter detection application can generate an edge binary image corresponding to the glass tube to be detected according to preset rules, a plurality of preset mask matrices, and the end face image.

Specifically, in this step, the specific process for the glass tube processing parameter detection application generates an edge binary image corresponding to the glass tube to be detected according to preset rules, a plurality of preset mask matrices, and the end face image is: performing a series of convolution operations processing on the end face image by using a plurality of preset mask matrices, and then generating the edge binary image according to a gray value of each of the pixel points in the convolved end face image, but not limited to this.

103: Determining a center coordinate corresponding to the first circular ring according to coordinates corresponding to each of the first pixel points, and determining a center coordinate corresponding to the second circular ring according to coordinates corresponding to each of the second pixel points.

Wherein, the center coordinate corresponding to the first circular ring is the coordinate corresponding to the center point of the first circular ring in the edge binary image, and the center coordinate corresponding to the second circular ring is the coordinate corresponding to the center point of the second circular ring in the edge binary image.

After the glass tube processing parameter detection application generates an edge binary image corresponding to the glass tube to be detected, the glass tube processing parameter detection application can determine a center coordinate corresponding to the first circular ring according to coordinates corresponding to each of the first pixel points in the edge binary image, and determine a center coordinate corresponding to the second circular ring according to coordinates corresponding to each of the second pixel points.

104: Determining an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring.

After the glass tube processing parameter detection application determine a center coordinate corresponding to the first circular ring and a center coordinate corresponding to the second circular ring, the glass tube processing parameter detection application can determine an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring.

Specifically, in this step, the glass tube processing parameter detection application can first determine the radius of the first ring in the image (that is, the radius corresponding to the first circular ring in the edge binary image) according to coordinates corresponding to each of the first pixel points and the center coordinate corresponding to the first circular ring, and determine the radius of the second ring in the image (that is, the radius corresponding to the second circular ring in the edge binary image) according to coordinates corresponding to each of the second pixel points and the center coordinate corresponding to the second circular ring; then, determine the image diameter corresponding to the first circular ring according to the radius of the first ring in the image and determine the image diameter corresponding to the second circular ring according to the radius of the second ring in the image; finally, perform unit conversion on the image diameter corresponding to the first circular ring and the image diameter corresponding to the second circular ring according to a pixel size in the edge binary image to obtain the inner-circle processing diameter and the outer-circle processing diameter corresponding to the glass tube to be detected, but not limited to this.

105: Determining a concentricity deviation value corresponding to the glass tube to be detected according to the center coordinate corresponding to the first circular ring and the center coordinate corresponding to the second circular ring.

After the glass tube processing parameter detection application determine a center coordinate corresponding to the first circular ring and a center coordinate corresponding to the second circular ring, the glass tube processing parameter detection application can determine a concentricity deviation value corresponding to the glass tube to be detected according to the center coordinate corresponding to the first circular ring and the center coordinate corresponding to the second circular ring.

Specifically, in this step, the glass tube processing parameter detection application can first determine the concentricity deviation value between the first circular ring and the second circular ring according to the center coordinate corresponding to the first circular ring and the center coordinate corresponding to the second circular ring; then, perform unit conversion on the concentricity deviation value between the first circular ring and the second circular ring according to a pixel size in the edge binary image to obtain the concentricity deviation value corresponding to the glass tube to be detected.

It should be noted that in the embodiment of the present application, the execution order of step 104 and step 105 is not specifically limited, that is, step 104 may be performed before step 105, or step 105 may be performed before step 104.

The embodiment of the present application provides a glass tube processing parameter detection method. In the embodiment of the present application, after a glass tube processing parameter detection application acquires an end face image corresponding to a glass tube to be detected, the glass tube processing parameter detection application first generates an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points; then, determines a center coordinate corresponding to the first circular ring according to coordinates corresponding to each of the first pixel points, and determines a center coordinate corresponding to the second circular ring according to coordinates corresponding to each of the second pixel points; then, determines an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring; finally, determines a concentricity deviation value corresponding to the glass tube to be detected according to the center coordinate corresponding to the first circular ring and the center coordinate corresponding to the second circular ring. Since, in the embodiment of the present application, detection staff only need to pre-shoot the end face image of the glass tube to be detected, the glass tube processing parameter detection application can detect the processing parameters corresponding to the glass tube to be detected based on the end face image corresponding to the glass tube to be detected, without requiring intervention from detection staff throughout the entire process, this can effectively reduce the time costs and labor costs consumed in detecting the processing parameters of the glass tube to be detected, thereby effectively improving detection efficiency.

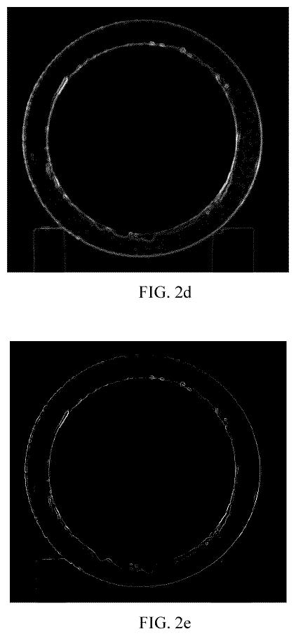

To provide a more detailed explanation, another embodiment of the present application provides another glass tube processing parameter detection method, specifically shown in FIG. 3. The method at least includes steps 201-206.

201: Acquiring an end face image corresponding to a glass tube to be detected.

Wherein, about step 201, acquiring an end face image corresponding to a glass tube to be detected, reference can be made to the description of the corresponding part of FIG. 1., the embodiment of the present application will not repeat it here.

202: Generating an edge binary image corresponding to the glass tube to be detected according to preset rules, a plurality of preset mask matrices, and the end face image.

After the glass tube processing parameter detection application acquires an end face image corresponding to a glass tube to be detected, the glass tube processing parameter detection application can generate an edge binary image corresponding to the glass tube to be detected according to preset rules, a plurality of preset mask matrices, and the end face image. The following will explain in detail how the glass tube processing parameter detection application generates an edge binary image corresponding to the glass tube to be detected according to preset rules, a plurality of preset mask matrices, and the end face image.

(1) Performing convolution operations processing on the end face image by using a plurality of preset mask matrices to obtain an edge image corresponding to the glass tube to be detected.

Wherein, a plurality of the preset mask matrices include a noise reduction mask matrix, a gradient mask matrix, and an edge mask matrix;

After the glass tube processing parameter detection application acquires an end face image corresponding to a glass tube to be detected, the glass tube processing parameter detection application can first perform convolution operations processing on the end face image by using a plurality of preset mask matrices to obtain an edge image corresponding to the glass tube to be detected. The specific process is: firstly, performing convolution operations processing on the end face image by using the noise reduction mask matrix to obtain a noise reduced image corresponding to the glass tube to be detected; second, performing convolution operations processing on the noise reduced image by using the gradient mask matrix to obtain a gradient image corresponding to the glass tube to be detected; finally, performing convolution operations processing on the gradient image by using the edge mask matrix to obtain the edge image corresponding to the glass tube to be detected.

It should be noted that performing convolution operations processing on the end face image by using the noise reduction mask matrix can improve image quality of the end face image and suppress noise points in the end face image; performing convolution operations processing on the noise reduced image by using the gradient mask matrix can ensure that it is sensitive to the gray value of the edge position of the glass tube in the noise reduced image without changing the overall gray of the noise reduced image, so that the gray value of the edge position of the glass tube can be retained as much as possible and the gray value of the background color can be effectively suppressed; performing convolution operations processing on the gradient image by using the edge mask matrix can enhance the gray value of the edge center point of the glass tube edge in the gradient image.

It should be noted that the type of convolution operations performed above is specifically the “same” convolution operations, that is, performing the “same” convolution operations processing on the end face image by using the noise reduction mask matrix; performing the “same” convolution operations processing on the noise reduced image by using the gradient mask matrix; performing the “same” convolution operations processing on the gradient image by using the edge mask matrix.

Wherein, the noise reduced image is specifically shown in FIG. 2c, the gradient image is specifically shown in FIG. 2d, and the edge image is specifically shown in FIG. 2e.

The noise reduction mask matrix is specifically:

| | | | | |
|---|---|---|---|---|
| 1/32 | 1/32 | 1/16 | 1/32 | 1/32 |
| 1/32 | 1/16 | ⅛ | 1/16 | 1/32 |
| 1/16 | ⅛ | ⅛ | ⅛ | 1/16 |
| 1/32 | 1/16 | ⅛ | 1/16 | 1/32 |
| 1/32 | 1/32 | 1/16 | 1/32 | 1/32 |

The gradient mask matrix is specifically:

| | | | | |
|---|---|---|---|---|
| 1/16 | 1/16 | 1/16 | 1/16 | 1/16 |
| 1/16 | −⅛ | −⅛ | −⅛ | 1/16 |
| 1/16 | −⅛ | 1 | −⅛ | 1/16 |
| 1/16 | −⅛ | −⅛ | −⅛ | 1/16 |
| 1/16 | 1/16 | 1/16 | 1/16 | 1/16 |

The edge mask matrix is specifically:

| | | | | |
|---|---|---|---|---|
| 1/64 | 1/64 | 1/64 | 1/64 | 1/64 |
| 1/64 | 1/32 | 1/32 | 1/32 | 1/64 |
| 1/64 | 1/32 | ½ | 1/32 | 1/64 |
| 1/64 | 1/32 | 1/32 | 1/32 | 1/64 |
| 1/64 | 1/64 | 1/64 | 1/64 | 1/64 |

(2) Generating the edge binary image corresponding to the glass tube to be detected according to a gray value corresponding to each of the pixel points in the edge image.

After the glass tube processing parameter detection application acquires the edge image corresponding to the glass tube to be detected, the glass tube processing parameter detection application can generate the edge binary image corresponding to the glass tube to be detected according to a gray value corresponding to each of the pixel points in the edge image. The specific process is: firstly, dividing a maximum gray value among gray values corresponding to each of the pixel points in the edge image by 2 to obtain a target gray value; then, determining pixel points in the edge image with gray values greater than the target gray value as third pixel points, and determining pixel points in the edge image with gray values less than or equal to the target gray value as fourth pixel points; then, generating a target image, wherein a plurality of pixel points in the target image correspond one-to-one with a plurality of pixel points in the edge image; finally, setting gray values of pixel points in the target image corresponding to each of the third pixel points to 1, and setting gray values of pixel points in the target image corresponding to each of the fourth pixel points to 0, to obtain the edge binary image. For example, determining the pixel point in the third row and the fifth column in the edge image as third pixel point, and setting the gray value of the pixel point in the third row and the fifth column in the target image to 1; determining the pixel point in the fifth row and the fifth column in the edge image as fourth pixel point, and setting the gray value of the pixel point in the fifth row and the fifth column in the target image to 0 . . .

203: Determining a center coordinate corresponding to the first circular ring according to coordinates corresponding to each of the first pixel points, and determining a center coordinate corresponding to the second circular ring according to coordinates corresponding to each of the second pixel points.

After the glass tube processing parameter detection application generates the edge binary image corresponding to the glass tube to be detected, the glass tube processing parameter detection application can determine a center coordinate corresponding to the first circular ring according to coordinates corresponding to each of the first pixel points in the edge binary image, and determine a center coordinate corresponding to the second circular ring according to coordinates corresponding to each of the second pixel points

Specifically, in this step, the specific process for the glass tube processing parameter detection application determines a center coordinate corresponding to the first circular ring according to coordinates corresponding to each of the first pixel points, and determines a center coordinate corresponding to the second circular ring according to coordinates corresponding to each of the second pixel points is:

(1) For any one of pixel points in the edge binary image, calculating distances from the pixel points to each of the first pixel points according to coordinates corresponding to the pixel points and coordinates corresponding to each of the first pixel points, and determining a maximum value among a plurality of the calculated distances as a first maximum distance corresponding to the pixel point, so that it is able to determine a first maximum distance corresponding to each of the pixel point in the edge binary image; determining a pixel point corresponding to a minimum value among a plurality of the determined first maximum distances as a center point corresponding to the first circular ring, and determining a coordinate corresponding to the center point as the center coordinate corresponding to the first circular ring;

(2) For any one of pixel points in the edge binary image, calculating distances from the pixel points to each of the second pixel points according to coordinates corresponding to the pixel points and coordinates corresponding to each of the second pixel points, and determining a maximum value among a plurality of the calculated distances as a second maximum distance corresponding to the pixel point, so that it is able to determine a second maximum distance corresponding to each of the pixel point in the edge binary image; determining a pixel point corresponding to a minimum value among a plurality of the determined second maximum distances as a center point corresponding to the second circular ring, and determining a coordinate corresponding to the center point as the center coordinate corresponding to the second circular ring.

It should be noted that for a plane containing a circle, when a point in the plane is outside the circle, the maximum distance from the point to the circle is the nearest distance from the point to the circle plus the diameter of the circle; when a point in the plane is on the circle, the maximum distance from the point to the circle is the diameter of the circle; when a point in the plane is inside the circle but not at the center, the maximum distance from the point to the circle is the distance from the point to the center plus the radius of the circle; when a point in the plane is at the center, the maximum distance from the point to the circle is the radius of the circle. Therefore, after determining the maximum distances from each of the points to the circle in the plane, a point corresponding to a minimum value among a plurality of the maximum distances is the center of the circle.

204: Determining an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring.

After the glass tube processing parameter detection application determining the center coordinate corresponding to the first circular ring and the center coordinate corresponding to the second circular ring, the glass tube processing parameter detection application can determine an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring.

Specifically, in this step, the specific process for the glass tube processing parameter detection application determines an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring is:
(1) Firstly, calculating a radius corresponding to each of the first pixel points according to coordinates corresponding to each of the first pixel points and a center coordinate corresponding to the first circular ring, that is, for any one of first pixel points, calculating the distance between the first pixel point and the center point of the first circular ring in the edge binary image according to the coordinate of the first pixel point in the edge binary image and a coordinate of the center point of the first circular ring in the edge binary image (that is, a center coordinate corresponding to the first circular ring), and determining the distance as the radius corresponding to the first pixel point; then, performing rounding processing on the radius corresponding to each of the first pixel points to obtain a candidate radius corresponding to each of the first pixel points; then, grouping a plurality of the first pixel points according to a candidate radius corresponding to each of the first pixel points to obtain a plurality of first groups, wherein, for any one of the first groups, the first group includes a plurality of first pixel points, and a candidate radius corresponding to a plurality of the first pixel points are the same; finally, determining a candidate radius corresponding to a group including a largest number of the first pixel points as an inner-circle image radius corresponding to the glass tube to be detected (that is, the radius corresponding to the first circular ring in the edge binary image);
(2) Firstly, calculating a radius corresponding to each of the second pixel points according to coordinates corresponding to each of the second pixel points and a center coordinate corresponding to the second circular ring, that is, for any one of second pixel points, calculating the distance between the second pixel point and the center point of the second circular ring in the edge binary image according to the coordinate of the second pixel point in the edge binary image and a coordinate of the center point of the second circular ring in the edge binary image (that is, a center coordinate corresponding to the second circular ring), and determining the distance as the radius corresponding to the second pixel point; then, performing rounding processing on the radius corresponding to each of the second pixel points to obtain a candidate radius corresponding to each of the second pixel points; then, grouping a plurality of the second pixel points according to a candidate radius corresponding to each of the second pixel points to obtain a plurality of second groups, wherein, for any one of the second groups, the second group includes a plurality of second pixel points, and a candidate radius corresponding to a plurality of the second pixel points are the same; finally, determining a candidate radius corresponding to a group including a largest number of the second pixel points as an outer-circle image radius corresponding to the glass tube to be detected (that is, the radius corresponding to the second circular ring in the edge binary image);
(3) Firstly, determining an inner-circle image diameter corresponding to the glass tube to be detected according to the inner-circle image radius calculated in step (1), that is, after multiplying the inner-circle image radius by 2, determining the calculated result as the inner-circle image diameter; then, determining an outer-circle image diameter corresponding to the glass tube to be detected according to the outer-circle image radius calculated in step (2), that is, after multiplying the outer-circle image radius by 2, determining the calculated result as the outer-circle image diameter.
(4) Determining the inner-circle processing diameter and the outer-circle processing diameter corresponding to the glass tube to be detected according to a pixel size corresponding to the edge binary image, the inner-circle image diameter and the outer-circle image diameter, that is, multiplying the inner-circle image diameter by the pixel size corresponding to the edge binary image to obtain the inner-circle processing diameter corresponding to the glass tube to be detected, and multiplying the outer-circle image diameter by the pixel size corresponding to the edge binary image to obtain the outer-circle processing diameter corresponding to the glass tube to be detected. For example, the pixel size corresponding to the edge binary image is 0.1 mm, the inner-circle image diameter is 288 pixels, thus the inner-circle processing diameter corresponding to the glass tube to be detected is 28.8 mm, the outer-circle image diameter is 358 pixels, thus the outer-circle processing diameter corresponding to the glass tube to be detected is 35.8 mm.

Wherein, the pixel size corresponding to the edge binary image is the side length of any one of pixel points (that is, the distance between two adjacent pixel points) in the edge binary image.

205: Determining a concentricity deviation value corresponding to the glass tube to be detected according to the center coordinate corresponding to the first circular ring and the center coordinate corresponding to the second circular ring.

After the glass tube processing parameter detection application determining the center coordinate corresponding to the first circular ring and the center coordinate corresponding to the second circular ring, the glass tube processing parameter detection application can determining a concentricity deviation value corresponding to the glass tube to be detected according to the center coordinate corresponding to the first circular ring and the center coordinate corresponding to the second circular ring.

Specifically, in this step, the specific process for the glass tube processing parameter detection application determines a concentricity deviation value corresponding to the glass tube to be detected according to the center coordinate corresponding to the first circular ring and the center coordinate corresponding to the second circular ring is:

Firstly, calculating an image concentricity deviation value corresponding to the glass tube to be detected according to the center coordinate corresponding to the first circular ring and the center coordinate corresponding to the second circular ring, that is, calculating the distance between the center point of the first circular ring and the center point of the second circular ring in the edge binary image according to a coordinate of the center point of the first circular ring in the edge binary image (that is, a center coordinate corresponding to the first circular ring) and a coordinate of the center point of the second circular ring in the edge binary image (that is, a center coordinate corresponding to the second circular ring), and determining the distance as the concentricity deviation value between the first circular ring and the second circular ring (that is, the concentricity deviation value of the image corresponding to the glass tube to be detected); then, determine the concentricity deviation value corresponding to the glass tube to be detected according to a pixel size corresponding to the edge binary image and the concentricity deviation value of the image, that is, multiplying the concentricity deviation value of the image by the pixel size corresponding to the edge binary image to obtain the concentricity deviation value corresponding to the glass tube to be detected.

It should be noted that in the embodiment of the present application, the execution order of step 204 and step 205 is not specifically limited, that is, step 204 may be performed before step 205, or step 205 may be performed before step 204.

206: Determining a processing grade corresponding to the glass tube to be detected according to the inner-circle processing diameter, the outer-circle processing diameter and the concentricity deviation value corresponding to the glass tube to be detected.

After the glass tube processing parameter detection application determining the inner-circle processing diameter, the outer-circle processing diameter and the concentricity deviation value corresponding to the glass tube to be detected, the glass tube processing parameter detection application can determine a processing grade corresponding to the glass tube to be detected according to the inner-circle processing diameter, the outer-circle processing diameter and the concentricity deviation value corresponding to the glass tube to be detected. The specific process is:
(1) Calculating a first relative error value corresponding to the glass tube to be detected according to the inner-circle processing diameter and an inner-circle drawing diameter corresponding to the glass tube to be detected, that is, substituting the inner-circle processing diameter and an inner-circle drawing diameter corresponding to the glass tube to be detected into a first formula to calculate a first relative error value corresponding to the glass tube to be detected, wherein the first formula is specifically as follows:

$$first relative error value = \frac{\vert ( inner - circle processing diameter ) - ( inner - circle drawing diameter ) \vert}{inner - circle drawing diameter}$$

(2) Calculating a second relative error value corresponding to the glass tube to be detected according to the outer-circle processing diameter and an outer-circle drawing diameter corresponding to the glass tube to be detected, that is, substituting the outer-circle processing diameter and an outer-circle drawing diameter corresponding to the glass tube to be detected into a second formula to calculate a second relative error value corresponding to the glass tube to be detected, wherein the second formula is specifically as follows:

$$second relative error value = \frac{\vert ( outer - circle processing diameter ) - ( outer - circle drawing diameter ) \vert}{outer - circle drawing diameter}$$

(3) Determining an inner-diameter processing grade and an outer-diameter processing grade corresponding to the glass tube to be detected according to the first relative error value and the second relative error value, that is, when the first relative error value is less than the first threshold value, determining the inner-diameter processing grade corresponding to the glass tube to be detected as first class; when the first relative error value is greater than or equal to the first threshold value and the first relative error value is less than the second threshold value, determining the inner-diameter processing grade corresponding to the glass tube to be detected as second class; when the first relative error value is greater than or equal to the second threshold value, determining the inner-diameter processing grade corresponding to the glass tube to be detected as third class; when the second relative error value is less than the first threshold value, determining the outer-diameter processing grade corresponding to the glass tube to be detected as first class; when the second relative error value is greater than or equal to the first threshold value and the second relative error value is less than the second threshold value, determining the outer-diameter processing grade corresponding to the glass tube to be detected as second class; when the second relative error value is greater than or equal to the second threshold value, determining the outer-diameter processing grade corresponding to the glass tube to be detected as third class; wherein, the first threshold can be, but not limited to, 2%, 2.5%, 3%, etc., and the second threshold can be, but not limited to, 5%, 5.5%, 6%, etc., and the second threshold is greater than the first threshold;
(4) Calculating an evaluation standard value according to the first relative error value and the second relative error value, that is, first calculating the sum of the first relative error value and the second relative error value to obtain a first calculation result, then, multiplying the first calculation result by 5 to obtain a second calculation result, and determining the second calculation result as the evaluation standard value;
(5) Calculating an inner-outer diameter difference value corresponding to the glass tube to be detected according to the inner-circle processing diameter and the outer-circle processing diameter, that is, after subtracting the outer-circle processing diameter from the inner-circle processing diameter, determining the calculated result as the inner-outer diameter difference value corresponding to the glass tube to be detected;
(6) Determining a concentricity processing grade corresponding to the glass tube to be detected according to the concentricity deviation value, the evaluation standard value and the inner-outer diameter difference value, that is, after dividing the concentricity deviation value by the inner-outer diameter difference value, comparing the calculated result with the evaluation standard value, when the calculated result is less than the evaluation standard value, determining the concentricity processing grade corresponding to the glass tube to be detected as first class; when the calculated result is greater than or equal to the evaluation standard value and the calculated result is less than twice the evaluation standard value, determining the concentricity processing grade corresponding to the glass tube to be detected as second class; when the calculated result is greater than twice the evaluation standard value, determining the concentricity processing grade corresponding to the glass tube to be detected as third class.

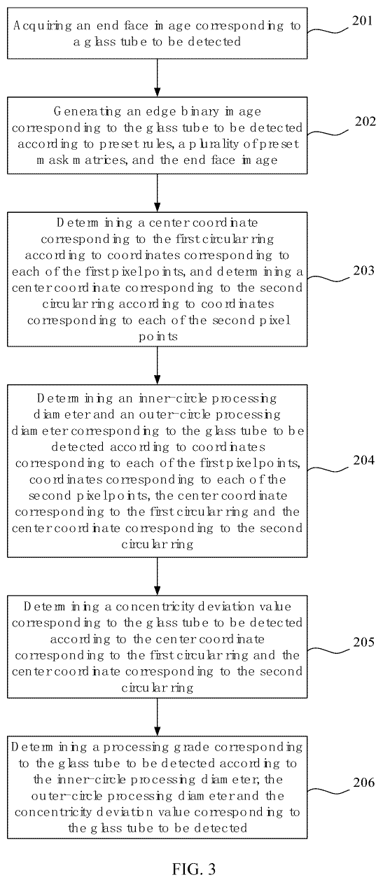

Furthermore, as an implementation of the above methods shown in FIG. 1 and FIG. 3, another embodiment of the present application further provides a glass tube processing parameter detection apparatus. This apparatus embodiment corresponds to the foregoing method embodiments. For ease of reading, this apparatus embodiment will not repeat the details of the foregoing method embodiments one by one, but it should be clear that the apparatus in the embodiment can correspondingly implement all the content of the foregoing method embodiments. The apparatus is applied to improve the detection efficiency of detecting the glass tube processing parameters. As shown specifically in FIG. 4, the apparatus includes:
An acquisition unit 31, configured to acquire an end face image corresponding to a glass tube to be detected, wherein the glass tube to be detected is a glass tube used for manufacturing optical fibers;
A generation unit 32, configured to generate an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points;
A first determination unit 33, configured to determine a center coordinate corresponding to the first circular ring according to coordinates corresponding to each of the first pixel points, and determine a center coordinate corresponding to the second circular ring according to coordinates corresponding to each of the second pixel points;
A second determination unit 34, configured to determine an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring;
A third determination unit 35, configured to determine a concentricity deviation value corresponding to the glass tube to be detected according to the center coordinate corresponding to the first circular ring and the center coordinate corresponding to the second circular ring.

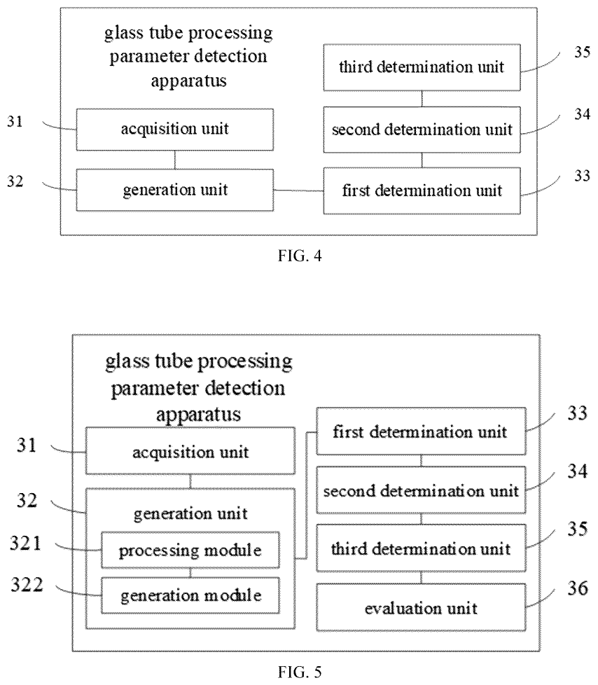

Furthermore, as shown in FIG. 5, the generation unit 32 includes:

A processing module 321, configured to perform convolution operations processing on the end face image by using a plurality of preset mask matrices to obtain an edge image corresponding to the glass tube to be detected.

A generation module 322, configured to generate the edge binary image corresponding to the glass tube to be detected according to a gray value corresponding to each of the pixel points in the edge image.

Furthermore, as shown in FIG. 5, a plurality of the preset mask matrices include a noise reduction mask matrix, a gradient mask matrix, and an edge mask matrix; the processing module 321 is specifically configured to perform convolution operations processing on the end face image by using the noise reduction mask matrix to obtain a noise reduced image corresponding to the glass tube to be detected; perform convolution operations processing on the noise reduced image by using the gradient mask matrix to obtain a gradient image corresponding to the glass tube to be detected; perform convolution operations processing on the gradient image by using the edge mask matrix to obtain the edge image corresponding to the glass tube to be detected.

Furthermore, as shown in FIG. 5, the generation module 322 is specifically configured to divide a maximum gray value among gray values corresponding to each of the pixel points in the edge image by 2 to obtain a target gray value; determine pixel points in the edge image with gray values greater than the target gray value as third pixel points, and determine pixel points in the edge image with gray values less than or equal to the target gray value as fourth pixel points; generate a target image, wherein a plurality of pixel points in the target image correspond one-to-one with a plurality of pixel points in the edge image; set gray values of pixel points in the target image corresponding to each of the third pixel points to 1, and set gray values of pixel points in the target image corresponding to each of the fourth pixel points to 0, to obtain the edge binary image.

Furthermore, as shown in FIG. 5, the first determination unit 33 is specifically configured to, for any one of pixel points in the edge binary image, calculate distances from the pixel points to each of the first pixel points according to coordinates corresponding to the pixel points and coordinates corresponding to each of the first pixel points, and determine a maximum value among a plurality of the distances as a first maximum distance corresponding to the pixel point; determine a pixel point corresponding to a minimum value among a plurality of the first maximum distances as a center point corresponding to the first circular ring, and determine a coordinate corresponding to the center point as the center coordinate corresponding to the first circular ring; for any one of pixel points in the edge binary image, calculate distances from the pixel points to each of the second pixel points according to coordinates corresponding to the pixel points and coordinates corresponding to each of the second pixel points, and determine a maximum value among a plurality of the distances as a second maximum distance corresponding to the pixel point; determine a pixel point corresponding to a minimum value among a plurality of the second maximum distances as a center point corresponding to the second circular ring, and determine a coordinate corresponding to the center point as the center coordinate corresponding to the second circular ring.

Furthermore, as shown in FIG. 5, the second determination unit 34 is specifically configured to calculate a radius corresponding to each of the first pixel points according to coordinates corresponding to each of the first pixel points and a center coordinate corresponding to the first circular ring; perform rounding processing on the radius corresponding to each of the first pixel points to obtain a candidate radius corresponding to each of the first pixel points; group a plurality of the first pixel points according to a candidate radius corresponding to each of the first pixel points to obtain a plurality of first groups, wherein, for any one of the first groups, the first group includes a plurality of first pixel points, and a candidate radius corresponding to a plurality of the first pixel points are the same; determine a candidate radius corresponding to a group including a largest number of the first pixel points as an inner-circle image radius corresponding to the glass tube to be detected; calculate a radius corresponding to each of the second pixel points according to coordinates corresponding to each of the second pixel points and a center coordinate corresponding to the second circular ring; perform rounding processing on the radius corresponding to each of the second pixel points to obtain a candidate radius corresponding to each of the second pixel points; group a plurality of the second pixel points according to a candidate radius corresponding to each of the second pixel points to obtain a plurality of second groups, wherein, for any one of the second groups, the second group includes a plurality of second pixel points, and a candidate radius corresponding to a plurality of the second pixel points are the same; determine a candidate radius corresponding to a group including a largest number of the second pixel points as an outer-circle image radius corresponding to the glass tube to be detected; determine an inner-circle image diameter corresponding to the glass tube to be detected according to the inner-circle image radius, and determine an outer-circle image diameter corresponding to the glass tube to be detected according to the outer-circle image radius; determine the inner-circle processing diameter and the outer-circle processing diameter corresponding to the glass tube to be detected according to a pixel size corresponding to the edge binary image, the inner-circle image diameter and the outer-circle image diameter.

Furthermore, as shown in FIG. 5, the third determination unit 35 is specifically configured to calculate an image concentricity deviation value corresponding to the glass tube to be detected according to the center coordinate corresponding to the first circular ring and the center coordinate corresponding to the second circular ring; determine the concentricity deviation value corresponding to the glass tube to be detected according to the pixel size corresponding to the edge binary image and the image concentricity deviation value.

Furthermore, as shown in FIG. 5, the apparatus further includes:

An evaluation unit 36, configured to calculate a first relative error value corresponding to the glass tube to be detected according to the inner-circle processing diameter and an inner-circle drawing diameter corresponding to the glass tube to be detected; calculate a second relative error value corresponding to the glass tube to be detected according to the outer-circle processing diameter and an outer-circle drawing diameter corresponding to the glass tube to be detected; determine an inner-diameter processing grade and an outer-diameter processing grade corresponding to the glass tube to be detected according to the first relative error value and the second relative error value; calculate an evaluation standard value according to the first relative error value and the second relative error value; calculate an inner-outer diameter difference value corresponding to the glass tube to be detected according to the inner-circle processing diameter and the outer-circle processing diameter; determine a concentricity processing grade corresponding to the glass tube to be detected according to the concentricity deviation value, the evaluation standard value and the inner-outer diameter difference value.

The embodiment of the present application provides a glass tube processing parameter detection method and apparatus. In the embodiment of the present application, after a glass tube processing parameter detection application acquires an end face image corresponding to a glass tube to be detected, the glass tube processing parameter detection application first generates an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points; then, determines a center coordinate corresponding to the first circular ring according to coordinates corresponding to each of the first pixel points, and determines a center coordinate corresponding to the second circular ring according to coordinates corresponding to each of the second pixel points; then, determines an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring; finally, determines a concentricity deviation value corresponding to the glass tube to be detected according to the center coordinate corresponding to the first circular ring and the center coordinate corresponding to the second circular ring. Since, in the embodiment of the present application, detection staff only need to pre-shoot the end face image of the glass tube to be detected, the glass tube processing parameter detection application can detect the processing parameters corresponding to the glass tube to be detected based on the end face image corresponding to the glass tube to be detected, without requiring intervention from detection staff throughout the entire process, this can effectively reduce the time costs and labor costs consumed in detecting the processing parameters of the glass tube to be detected, thereby effectively improving detection efficiency.

An embodiment of the present application provides a storage medium. The storage medium includes a stored program, wherein the program, when executed, controls a device in which the storage medium is located to perform the glass tube processing parameter detection method described above.

The storage medium may include the forms of non-permanent memory, random access memory (RAM), and/or non-volatile memory in computer-readable media, such as read-only memory (ROM) or flash memory (flash RAM). The memory includes at least one storage chip.

An embodiment of the present application further provides a glass tube processing parameter detection apparatus. The apparatus includes a storage medium; and one or more processors, the storage medium is coupled to the processor, and the processor is configured to execute program instructions stored in the storage medium; the program instructions, when running, execute the glass tube processing parameter detection method described above.

An embodiment of the present application provides a device. The device includes a processor, a memory, and a program stored on the memory and executable on the processor. When the processor executes the program, it performs the following steps:
Acquiring an end face image corresponding to a glass tube to be detected, wherein the glass tube to be detected is a glass tube used for manufacturing optical fibers;
Generating an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points;
Determining a center coordinate corresponding to the first circular ring according to coordinates corresponding to each of the first pixel points, and determining a center coordinate corresponding to the second circular ring according to coordinates corresponding to each of the second pixel points;
Determining an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring;
Determining a concentricity deviation value corresponding to the glass tube to be detected according to the center coordinate corresponding to the first circular ring and the center coordinate corresponding to the second circular ring.

Furthermore, the step of generating an edge binary image corresponding to the glass tube to be detected according to preset rules, a plurality of preset mask matrices, and the end face image includes:
Performing convolution operations processing on the end face image by using a plurality of preset mask matrices to obtain an edge image corresponding to the glass tube to be detected;
Generating the edge binary image corresponding to the glass tube to be detected according to a gray value corresponding to each of the pixel points in the edge image.

Furthermore, a plurality of the preset mask matrices include a noise reduction mask matrix, a gradient mask matrix, and an edge mask matrix; the step of performing convolution operations processing on the end face image by using a plurality of preset mask matrices to obtain an edge image corresponding to the glass tube to be detected includes:
Performing convolution operations processing on the end face image by using the noise reduction mask matrix to obtain a noise reduced image corresponding to the glass tube to be detected;
Performing convolution operations processing on the noise reduced image by using the gradient mask matrix to obtain a gradient image corresponding to the glass tube to be detected;
Performing convolution operations processing on the gradient image by using the edge mask matrix to obtain the edge image corresponding to the glass tube to be detected.

Furthermore, the step of generating the edge binary image corresponding to the glass tube to be detected according to a gray value corresponding to each of the pixel points in the edge image includes:
Dividing a maximum gray value among gray values corresponding to each of the pixel points in the edge image by 2 to obtain a target gray value;
Determining pixel points in the edge image with gray values greater than the target gray value as third pixel points, and determining pixel points in the edge image with gray values less than or equal to the target gray value as fourth pixel points;
Generating a target image, wherein a plurality of pixel points in the target image correspond one-to-one with a plurality of pixel points in the edge image;
Setting gray values of pixel points in the target image corresponding to each of the third pixel points to 1, and setting gray values of pixel points in the target image corresponding to each of the fourth pixel points to 0, to obtain the edge binary image.

Furthermore, the step of determining a center coordinate corresponding to the first circular ring according to coordinates corresponding to each of the first pixel points, and determining a center coordinate corresponding to the second circular ring according to coordinates corresponding to each of the second pixel points includes:
For any one of pixel points in the edge binary image, calculating distances from the pixel points to each of the first pixel points according to coordinates corresponding to the pixel points and coordinates corresponding to each of the first pixel points, and determining a maximum value among a plurality of the distances as a first maximum distance corresponding to the pixel point;
Determining a pixel point corresponding to a minimum value among a plurality of the first maximum distances as a center point corresponding to the first circular ring, and determining a coordinate corresponding to the center point as the center coordinate corresponding to the first circular ring;
For any one of pixel points in the edge binary image, calculating distances from the pixel points to each of the second pixel points according to coordinates corresponding to the pixel points and coordinates corresponding to each of the second pixel points, and determining a maximum value among a plurality of the distances as a second maximum distance corresponding to the pixel point;
Determining a pixel point corresponding to a minimum value among a plurality of the second maximum distances as a center point corresponding to the second circular ring, and determining a coordinate corresponding to the center point as the center coordinate corresponding to the second circular ring.

Furthermore, the step of determining an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring includes:
Calculating a radius corresponding to each of the first pixel points according to coordinates corresponding to each of the first pixel points and a center coordinate corresponding to the first circular ring;
Performing rounding processing on the radius corresponding to each of the first pixel points to obtain a candidate radius corresponding to each of the first pixel points;
Grouping a plurality of the first pixel points according to a candidate radius corresponding to each of the first pixel points to obtain a plurality of first groups, wherein, for any one of the first groups, the first group includes a plurality of first pixel points, and a candidate radius corresponding to a plurality of the first pixel points are the same;
Determining a candidate radius corresponding to a group including a largest number of the first pixel points as an inner-circle image radius corresponding to the glass tube to be detected;
Calculating a radius corresponding to each of the second pixel points according to coordinates corresponding to each of the second pixel points and a center coordinate corresponding to the second circular ring;
Performing rounding processing on the radius corresponding to each of the second pixel points to obtain a candidate radius corresponding to each of the second pixel points;
Grouping a plurality of the second pixel points according to a candidate radius corresponding to each of the second pixel points to obtain a plurality of second groups, wherein, for any one of the second groups, the second group includes a plurality of second pixel points, and a candidate radius corresponding to a plurality of the second pixel points are the same;
Determining a candidate radius corresponding to a group including a largest number of the second pixel points as an outer-circle image radius corresponding to the glass tube to be detected;
Determining an inner-circle image diameter corresponding to the glass tube to be detected according to the inner-circle image radius, and determining an outer-circle image diameter corresponding to the glass tube to be detected according to the outer-circle image radius;
Determining the inner-circle processing diameter and the outer-circle processing diameter corresponding to the glass tube to be detected according to a pixel size corresponding to the edge binary image, the inner-circle image diameter and the outer-circle image diameter.

Furthermore, the step of determining a concentricity deviation value corresponding to the glass tube to be detected according to the center coordinate corresponding to the first circular ring and the center coordinate corresponding to the second circular ring includes:
Calculating an image concentricity deviation value corresponding to the glass tube to be detected according to the center coordinate corresponding to the first circular ring and the center coordinate corresponding to the second circular ring;
Determining the concentricity deviation value corresponding to the glass tube to be detected according to the pixel size corresponding to the edge binary image and the image concentricity deviation value.

Furthermore, the method further includes:
Calculating a first relative error value corresponding to the glass tube to be detected according to the inner-circle processing diameter and an inner-circle drawing diameter corresponding to the glass tube to be detected;
Calculating a second relative error value corresponding to the glass tube to be detected according to the outer-circle processing diameter and an outer-circle drawing diameter corresponding to the glass tube to be detected;
Determining an inner-diameter processing grade and an outer-diameter processing grade corresponding to the glass tube to be detected according to the first relative error value and the second relative error value;
Calculating an evaluation standard value according to the first relative error value and the second relative error value;
Calculating an inner-outer diameter difference value corresponding to the glass tube to be detected according to the inner-circle processing diameter and the outer-circle processing diameter;
Determining a concentricity processing grade corresponding to the glass tube to be detected according to the concentricity deviation value, the evaluation standard value and the inner-outer diameter difference value.

The present application further provides a computer program product. When executed on a data processing device, it is suitable to execute program code initialized with the following method steps: acquiring an end face image corresponding to a glass tube to be detected, wherein the glass tube to be detected is a glass tube used for manufacturing optical fibers; generating an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points; determining a center coordinate corresponding to the first circular ring according to coordinates corresponding to each of the first pixel points, and determining a center coordinate corresponding to the second circular ring according to coordinates corresponding to each of the second pixel points; determining an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring; determining a concentricity deviation value corresponding to the glass tube to be detected according to the center coordinate corresponding to the first circular ring and the center coordinate corresponding to the second circular ring.

Those skilled in the art will understand that embodiments of the present application can be provided as a method, system or computer program product. Accordingly, the present application can take the form of an entirely hardware embodiment, an entirely software embodiment or an embodiment combining software and hardware aspects. Furthermore, the present application can take the form of a computer program product implemented on one or more computer-usable storage media (including but not limited to disk storage, CD-ROM, optical storage, etc.) containing computer-usable program codes.

The present application is described with reference to flowcharts and/or block diagrams of methods, devices (systems), and computer program products according to embodiments of the present application. It should be understood that each process and/or block in the flowcharts and/or block diagrams, and combinations of processes and/or blocks in the flowcharts and/or block diagrams, can be implemented by computer program instructions. These computer program instructions can be provided to a processor of a general-purpose computer, a special-purpose computer, an embedded processor, or other programmable data processing device to produce a machine, such that the instructions, which execute through the processor of the computer or other programmable data processing device, produce apparatuses for implementing the functions specified in one or more processes in the flowchart and/or one or more blocks in the block diagram.

These computer program instructions can also be stored in a computer-readable memory that can direct a computer or other programmable data processing device to function in a particular manner, such that the instructions stored in the computer-readable memory produce an article of manufacture including instruction apparatuses, the instruction apparatuses implement the functions specified in one or more processes in the flowchart and/or one or more blocks in the block diagram.

These computer program instructions can also be loaded onto a computer or other programmable data processing device to cause a series of operational steps to be executed on the computer or other programmable device to produce a computer-implemented process, such that the instructions which execute on the computer or other programmable device provide steps for implementing the functions specified in one or more processes in the flowchart and/or one or more blocks in the block diagram.

In a typical configuration, a computing device includes one or more processors (CPU), input/output interfaces, network interfaces, and memory.

The memory may include the forms of non-permanent memory, random access memory (RAM), and/or non-volatile memory in computer-readable media, such as read-only memory (ROM) or flash memory (flash RAM). The memory is an example of computer-readable media.

Computer-readable media include permanent and non-permanent, removable and non-removable media that can store information by any method or technology. Information can be computer-readable instructions, data structures, program modules, or other data. Examples of computer storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic cassettes, magnetic tape magnetic disk storage or other magnetic storage devices, or any other non-transitory medium that can be used to store information accessible by a computing device. As defined herein, computer-readable media does not include transitory media, such as modulated data signals and carrier waves.

It should also be noted that the terms “including”, “comprising”, or any of their variations are intended to cover non-exclusive inclusion, thereby enabling a process, method, product or device that includes a series of elements to not only include those elements, but also to include other elements that are not explicitly listed, or to include elements inherent to such a process, method, product or device. Without further limitations, the elements limited by the statement “including one . . . ” do not exclude the existence of other identical elements in the process, method, product or device that includes those elements.

It should be understood by those skilled in the art that the embodiments of the present application may be implemented as methods, systems or computer program products. Therefore, the present application may take the form of a fully hardware implementation, a fully software implementation, or an implementation combining software and hardware aspects. Moreover, the present application can take the form of a computer program product implemented on one or more computer-usable storage media (including but not limited to disk storage, CD-ROM, optical storage, etc.) containing computer-usable program codes.

The above are merely embodiments of the present application and do not limit the scope of the present application. For those skilled in the art, the present application may have various modifications and variations. Any changes, equivalents, improvements, etc. made within the spirit and principles of the present application shall be included within the scope of the claims of the present application.

1. A glass tube processing parameter detection method, comprising:
acquiring an end face image corresponding to a glass tube to be detected, wherein the glass tube to be detected is a glass tube used for manufacturing optical fibers;
generating an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points;
determining a center coordinate corresponding to the first circular ring according to coordinates corresponding to each of the first pixel points, and determining a center coordinate corresponding to the second circular ring according to coordinates corresponding to each of the second pixel points;
determining an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring; and
determining a concentricity deviation value corresponding to the glass tube to be detected according to the center coordinate corresponding to the first circular ring and the center coordinate corresponding to the second circular ring.

2. The method according to claim 1, wherein the step of generating an edge binary image corresponding to the glass tube to be detected according to preset rules, a plurality of preset mask matrices, and the end face image comprises:
performing convolution operations processing on the end face image by using a plurality of preset mask matrices to obtain an edge image corresponding to the glass tube to be detected;
generating the edge binary image corresponding to the glass tube to be detected according to a gray value corresponding to each of the pixel points in the edge image.

3. The method according to claim 2, wherein a plurality of the preset mask matrices include a noise reduction mask matrix, a gradient mask matrix, and an edge mask matrix; the step of performing convolution operations processing on the end face image by using a plurality of preset mask matrices to obtain an edge image corresponding to the glass tube to be detected comprises:
performing convolution operations processing on the end face image by using the noise reduction mask matrix to obtain a noise reduced image corresponding to the glass tube to be detected;
performing convolution operations processing on the noise reduced image by using the gradient mask matrix to obtain a gradient image corresponding to the glass tube to be detected;
performing convolution operations processing on the gradient image by using the edge mask matrix to obtain the edge image corresponding to the glass tube to be detected.

4. The method according to claim 2, wherein the step of generating the edge binary image corresponding to the glass tube to be detected according to a gray value corresponding to each of the pixel points in the edge image comprises:
dividing a maximum gray value among gray values corresponding to each of the pixel points in the edge image by 2 to obtain a target gray value;
determining pixel points in the edge image with gray values greater than the target gray value as third pixel points, and determining pixel points in the edge image with gray values less than or equal to the target gray value as fourth pixel points;
generating a target image, wherein a plurality of pixel points in the target image correspond one-to-one with a plurality of pixel points in the edge image;
setting gray values of pixel points in the target image corresponding to each of the third pixel points to 1, and setting gray values of pixel points in the target image corresponding to each of the fourth pixel points to 0, to obtain the edge binary image.

5. The method according to claim 1, wherein the step of determining a center coordinate corresponding to the first circular ring according to coordinates corresponding to each of the first pixel points, and determining a center coordinate corresponding to the second circular ring according to coordinates corresponding to each of the second pixel points comprises:
for any one of pixel points in the edge binary image, calculating distances from the pixel points to each of the first pixel points according to coordinates corresponding to the pixel points and coordinates corresponding to each of the first pixel points, and determining a maximum value among a plurality of the distances as a first maximum distance corresponding to the pixel point;
determining a pixel point corresponding to a minimum value among a plurality of the first maximum distances as a center point corresponding to the first circular ring, and determining a coordinate corresponding to the center point as the center coordinate corresponding to the first circular ring;
for any one of pixel points in the edge binary image, calculating distances from the pixel points to each of the second pixel points according to coordinates corresponding to the pixel points and coordinates corresponding to each of the second pixel points, and determining a maximum value among a plurality of the distances as a second maximum distance corresponding to the pixel point;
determining a pixel point corresponding to a minimum value among a plurality of the second maximum distances as a center point corresponding to the second circular ring, and determining a coordinate corresponding to the center point as the center coordinate corresponding to the second circular ring.

6. The method according to claim 1, wherein the step of determining an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring comprises:
calculating a radius corresponding to each of the first pixel points according to coordinates corresponding to each of the first pixel points and a center coordinate corresponding to the first circular ring;
performing rounding processing on the radius corresponding to each of the first pixel points to obtain a candidate radius corresponding to each of the first pixel points;
grouping a plurality of the first pixel points according to a candidate radius corresponding to each of the first pixel points to obtain a plurality of first groups, wherein, for any one of the first groups, the first group includes a plurality of first pixel points, and a candidate radius corresponding to a plurality of the first pixel points are the same;
determining a candidate radius corresponding to a group including a largest number of the first pixel points as an inner-circle image radius corresponding to the glass tube to be detected;
calculating a radius corresponding to each of the second pixel points according to coordinates corresponding to each of the second pixel points and a center coordinate corresponding to the second circular ring;
performing rounding processing on the radius corresponding to each of the second pixel points to obtain a candidate radius corresponding to each of the second pixel points;
grouping a plurality of the second pixel points according to a candidate radius corresponding to each of the second pixel points to obtain a plurality of second groups, wherein, for any one of the second groups, the second group includes a plurality of second pixel points, and a candidate radius corresponding to a plurality of the second pixel points are the same;
determining a candidate radius corresponding to a group including a largest number of the second pixel points as an outer-circle image radius corresponding to the glass tube to be detected;
determining an inner-circle image diameter corresponding to the glass tube to be detected according to the inner-circle image radius, and determining an outer-circle image diameter corresponding to the glass tube to be detected according to the outer-circle image radius;
determining the inner-circle processing diameter and the outer-circle processing diameter corresponding to the glass tube to be detected according to a pixel size corresponding to the edge binary image, the inner-circle image diameter and the outer-circle image diameter.

7. The method according to claim 1, wherein the step of determining a concentricity deviation value corresponding to the glass tube to be detected according to the center coordinate corresponding to the first circular ring and the center coordinate corresponding to the second circular ring comprises:
calculating an image concentricity deviation value corresponding to the glass tube to be detected according to the center coordinate corresponding to the first circular ring and the center coordinate corresponding to the second circular ring;
determining the concentricity deviation value corresponding to the glass tube to be detected according to the pixel size corresponding to the edge binary image and the image concentricity deviation value.

8. The method according to claim 1, the method further comprising:
calculating a first relative error value corresponding to the glass tube to be detected according to the inner-circle processing diameter and an inner-circle drawing diameter corresponding to the glass tube to be detected;
calculating a second relative error value corresponding to the glass tube to be detected according to the outer-circle processing diameter and an outer-circle drawing diameter corresponding to the glass tube to be detected;
determining an inner-diameter processing grade and an outer-diameter processing grade corresponding to the glass tube to be detected according to the first relative error value and the second relative error value;
calculating an evaluation standard value according to the first relative error value and the second relative error value;
calculating an inner-outer diameter difference value corresponding to the glass tube to be detected according to the inner-circle processing diameter and the outer-circle processing diameter;
determining a concentricity processing grade corresponding to the glass tube to be detected according to the concentricity deviation value, the evaluation standard value and the inner-outer diameter difference value.

9. A glass tube processing parameter detection apparatus, comprising:
an acquisition unit, configured to acquire an end face image corresponding to a glass tube to be detected, wherein the glass tube to be detected is a glass tube used for manufacturing optical fibers;
a generation unit, configured to generate an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points;
a first determination unit, configured to determine a center coordinate corresponding to the first circular ring according to coordinates corresponding to each of the first pixel points, and determine a center coordinate corresponding to the second circular ring according to coordinates corresponding to each of the second pixel points;
a second determination unit, configured to determine an inner-circle processing diameter and an outer-circle processing diameter corresponding to the glass tube to be detected according to coordinates corresponding to each of the first pixel points, coordinates corresponding to each of the second pixel points, the center coordinate corresponding to the first circular ring and the center coordinate corresponding to the second circular ring;
a third determination unit, configured to determine a concentricity deviation value corresponding to the glass tube to be detected according to the center coordinate corresponding to the first circular ring and the center coordinate corresponding to the second circular ring.

10. A storage medium comprising a stored program, wherein the program, when executed, controls a device in which the storage medium is located to perform the glass tube processing parameter detection method according to claim 1.
